(19) United States
(12) Patent Application Publication
(10) Pub. No.: US 2026/0079999 A1
(43) Pub. Date: Mar. 19, 2026

(54) SYSTEMS AND METHODS FOR ASSESSING TEXTUAL EMBEDDINGS USING AN UNLABELED DATASET ASSOCIATED WITH A FACILITY

(71) Applicant: Honeywell International Inc., Charlotte, NC (US)

(72) Inventors: Waad Subber, Schenectady, NY (US); Ankit Singh, Apex, NC (US)

(21) Appl. No.: 18/889,414

(22) Filed: Sep. 19, 2024

(51) Int. Cl. G06F 16/35

(52) U.S. Cl. CPC G06F 16/355

(57) ABSTRACT

Various embodiments described herein relate to systems and methods for assessing one or more textual embeddings using an unlabeled dataset associated with a facility. The unlabeled dataset is retrieved from a database and provided to a language learning model. A labeled dataset is generated using the language learning model. Considering one or more portions of the labeled dataset, a proxy task is constructed. The proxy task comprises the one or more textual embeddings along with one or more evaluation metrics and one or more machine learning models. The proxy task is then executed for each of the one or more textual embeddings. Then, one or more performance metrics for each of the one or more textual embeddings is determined. Based on the one or more performance metrics, one of the one or more machine learning models is selected. Using the selected machine learning model, operations in the facility is optimized.

### TECHNICAL FIELD

The present disclosure generally relates to a data management system. More particularly, the present disclosure relates to assessing one or more textual embeddings by relying on unlabeled dataset associated with a facility.

### BACKGROUND

Generally, a facility related to life sciences sector such as a pharmaceutical industry, a medical device company, a healthcare firm, and/or the like often handles vast amount of data. This data may be generated across different domains or due to various operations within the facility. The facility leverages such operational data and tries to derive insights to facilitate hassle free operations such as investigation, complaint management, and/or the like in the facility. In this regard, the facility often relies on traditional natural language processing (NLP) techniques to uncover insights such as correlations, trends, patterns, and/or the like associated with the operational data. However, such traditional techniques have several shortcomings. For instance, such techniques may fail to consider interrelationship between terms in the operational data. In another instance, such techniques may fail to capture semantic meaning of terms in the operational data. Additionally, the insights may not completely convey actual meaning due to omission of interrelationship between terms and/or semantic meaning of terms. These may also lead to misinterpretation of the operational data and the insights derived may be unreliable. Such unreliable insights further impact the operations of the facility which may lead to decreased productivity of the facility. Accordingly, such shortcomings make traditional techniques inefficient for analysis of the operational data in the facility.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques, in accordance with one or more example embodiments described herein.

FIG. 3 illustrates a schematic diagram showing an implementation of an exemplary embedding assessment system, in accordance with one or more example embodiments described herein.

FIG. 4 illustrates a schematic diagram showing an exemplary user interface rendering one or more exemplary instruction prompts, in accordance with one or more example embodiments described herein.

FIG. 5 illustrates a schematic diagram showing an exemplary labeled dataset, in accordance with one or more example embodiments described herein.

FIG. 6 illustrates a schematic diagram showing an exemplary representation of one or more performance metrics, in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

FIG. 11 illustrates a flowchart showing a method described in accordance with one or more example embodiments described herein.

FIG. 12 illustrates a flowchart showing a method described in accordance with one or more example embodiments described herein.

FIG. 13 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for assessing one or more textual embeddings using an unlabeled dataset associated with a facility is described herein. In this regard, the method comprises retrieving from a database the unlabeled dataset associated with the facility. Further, the method comprises providing the unlabeled dataset to a language learning model. Then, the method comprises generating a labeled dataset using the language learning model. This is based at least on the unlabeled dataset provided to the language learning model. Furthermore, the method comprises constructing a proxy task using one or more portions of the labeled dataset. In this regard, the proxy task comprises the one or more textual embeddings along with one or more evaluation metrics and one or more machine learning models. The method then comprises executing the proxy task for each of the one or more textual embeddings. Based on the execution of the proxy task, the method then comprises determining one or more performance metrics for each of the one or more textual embeddings. Based on the one or more performance metrics, the method comprises selecting one of the one or more machine learning models. Using the selected machine learning model, the method comprises optimizing one or more operations in the facility.

In accordance with another embodiment of the current disclosure, a system for assessing one or more textual embeddings using an unlabeled dataset associated with a facility is described herein. The system comprises a processor and a memory communicatively coupled to the processor, wherein the memory comprises one or more instructions which when executed by the processor, cause the processor to retrieve the unlabeled dataset associated with the facility from a database. The processor is then configured to provide the unlabeled dataset to a language learning model. Based at least on the unlabeled dataset provided to the language learning model, a labeled dataset using the language learning model is then generated by the processor. The processor is further configured to construct a proxy task using one or more portions of the labeled dataset. In this regard, the proxy task comprises the one or more textual embeddings along with one or more evaluation metrics and one or more machine learning models. Then, the processor is configured to execute the proxy task for each of the one or more textual embeddings. Based on the execution of the proxy task, the processor is configured to determine one or more performance metrics for each of the one or more textual embeddings. Using the one or more performance metrics, the processor is configured to select one of the one or more machine learning models. The processor is then configured to optimize one or more operations in the facility using the selected machine learning model.

In accordance with yet another embodiment of the current disclosure, a non-transitory, computer-readable storage medium having instructions stored thereon and executable by one or more processors is described herein. In this regard, the instructions when executed by one or more processors cause the one or more processors to retrieve an unlabeled dataset associated with a facility from a database. Further, the one or more processors are configured to provide the unlabeled dataset to a language learning model. Based at least on the unlabeled dataset provided to the language learning model, a labeled dataset using the language learning model is then generated by the one or more processors. The one or more processors are further configured to construct a proxy task using one or more portions of the labeled dataset. In this regard, the proxy task comprises the one or more textual embeddings along with one or more evaluation metrics and one or more machine learning models. Then, the one or more processors are configured to execute the proxy task for each of the one or more textual embeddings. Based on the execution of the proxy task, the one or more processors are configured to determine one or more performance metrics for each of the one or more textual embeddings. Using the one or more performance metrics, the one or more processors are configured to select one of the one or more machine learning models. The one or more processors are then configured to optimize one or more operations in the facility using the selected machine learning model.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

One or more example embodiments of the present disclosure may provide a platform or a framework in a facility that uses real-time accurate machine learning models and visual analytics to handle data associated with the facility. The platform is an extensible platform that is portable for deployment in any cloud or data center environment for providing an enterprise-wide, top to bottom view, displaying status of processes (or operations), assets, people, and/or the like. Further, the platform of the present disclosure supports end-to-end capability using data associated with the facility to provide appropriate analyses and/or predictions related to the facility as well.

More specifically, a facility may rely on conventional natural language processing (NLP) techniques to analyze operational data associated with the facility. The operational data often comprises historical data and real/near-real time data related to operations in the facility. Upon analysis of the operational data, insights such as correlations, trends, patterns, and/or the like may be derived from the operational data. These insights often minimize redundancy and optimize operations such as, investigation process, complaint management, and/or the like in the facility. To analyze the operational data, the facility may rely on traditional techniques such as count vectorization (which corresponds to machine learning (ML) technique used in NLP to represent text documents as numerical vectors). Often such techniques may be used during different phases of data management in the facility. That is, the facility may rely on such techniques for tasks such as text classification, clustering, information retrieval, and/or the like. Though techniques such as count vectorization offer scalability and simplicity in implementation which are advantageous, but there are some shortcomings too. Firstly, techniques such as count vectorization do not capture semantic meaning of words in a dataset. That is, such techniques treat each word independently, which may limit its effectiveness for tasks requiring deeper understanding of language. Secondly, techniques such as count vectorization fail to consider relationships between terms in a dataset which may restrain insights derived from the operational data. Thirdly, at times, at least some of the operational data may be unlabeled making it difficult for said techniques to identify context and then analyze unlabeled data. So, there exists a need to develop an advanced framework for deriving better insights from the operational data so as to achieve efficient operations in the facility.

Proposes to develop systems and methods for assessing textual embeddings using an unlabeled dataset associated with the facility. In this regard, for instance, the system described herein corresponds to a framework that analyzes the textual embeddings using the unlabeled dataset and then develops a strategy to select an optimal machine learning model, validate the same, and continuously enhance working of the optimal machine learning model. Such machine learning model is then used to optimize one or more operations in the facility. Per this aspect, the one or more operations may be, but not limited to complaint management, investigation process, and/or the like in the facility. Initially, the system described herein retrieves unlabeled dataset associated with the facility. This may be retrieved from a database which stores all relevant data (historical data and real/near-time data) associated with the facility. The unlabeled dataset corresponds to a portion of the data in the database. Said alternatively, the database may additionally comprise other data related to the facility apart from the unlabeled dataset. The unlabeled dataset described herein for instance, may correspond to a historical dataset of complaints which comprises multiple records of complaints. The unlabeled dataset is selected based on requirements and/or operations to be optimized in the facility as well. For example, to optimize an investigation process for complaints received from various customers, a historical set of related complaints may be chosen.

Upon selecting and retrieving the unlabeled dataset, the system described herein inputs the unlabeled dataset into a language learning model. In this regard, the language learning model may be, but not limited to Gemini, ChatGPT, and/or the like. Along with the unlabeled dataset, a user associated with the facility also provides one or more instruction prompts. These instruction prompts may be provided via a user interface of the system described herein. The instruction prompts correspond to one or more natural language statements provided by the user and often comprise instructions or requirements of the user. The one or more instruction prompts are often directed to generate semantic data relative to the unlabeled dataset, label the unlabeled dataset, and/or the like. The language learning model then analyzes the unlabeled dataset in light of such instruction prompts. In this regard, the language learning model analyzes each record in the unlabeled dataset. Also, the language learning model generates a semantic dataset in the course of analysis of the unlabeled dataset. The semantic dataset may correspond to randomly generated dataset by the language learning model based at least on the unlabeled dataset. For each record in the unlabeled dataset, the language learning model generates a corresponding record as a part of the semantic dataset. In this regard, the semantic dataset comprises records similar to and/or dissimilar to the unlabeled dataset. Upon such analysis, the language learning model then outputs a labeled dataset. This dataset comprises each record in the unlabeled dataset and a corresponding record from the semantic dataset, along with a label. The label described herein corresponds to an indicator that indicates similarity/dissimilarity (alternatively, like/unlike) between a record in the unlabeled dataset when compared to its corresponding record in the semantic dataset. Accordingly, the record in the unlabeled dataset and its corresponding record from the semantic dataset will be labeled with a same label.

The labeled dataset is then categorized into training dataset, validation dataset, and observation dataset. In this regard, the system employs techniques such as, but not limited to stratified sampling techniques to categorize the labeled dataset. It is to be noted that number of records or content in the training dataset may be relatively greater than that in the validation dataset and the observation dataset. Upon such categorization, the system utilizes the training dataset and the validation dataset to construct a proxy task. While the observation dataset is passed to a human annotator for validation and for gathering feedback. The proxy task comprises one or more textual embeddings along with one or more evaluation metrics and one or more machine learning models. Each textual embedding comprises a corresponding semantic encoding technique that vectorizes each record in the unlabeled dataset and a corresponding record in the semantic dataset as well. That is, the said semantic encoding technique converts textual representations in a record from the unlabeled dataset and textual representations in a corresponding record in the semantic dataset to respective vectorial representations. Whereas the one or more evaluation metrics are used to measure similarity between records in the unlabeled dataset and corresponding records in the semantic dataset. In this regard, the one or more evaluation metrics may be, but not limited to Euclidean distance, Pearson correlation coefficient, Cosine similarity, and/or the like. The said evaluation metric(s) yield a continuous measure between 0 and 1 such that the measure corresponds to a similarity score indicative of a degree of similarity between a record from the unlabeled dataset and a corresponding record in the semantic dataset. The one or more machine learning models in the proxy task may correspond to one or more classification models that are used to classify various data associated with the facility. It is to be noted that each of the machine learning models in the proxy task are sufficiently trained to classify required datasets.

Further, the system executes the proxy task for each of the one or more textual embeddings. In this regard, the system passes the training dataset and the validation dataset for usage by corresponding machine learning models in the proxy task. The corresponding machine learning models further classify appropriate records in the unlabeled dataset and corresponding records in the semantic dataset to be similar/dissimilar. This classification is based on the similarity score derived earlier. With this, the corresponding machine learning models measure an accuracy of semantic similarity between related records that are compared. Based at least on this, the system then determines one or more performance metrics for each of the one or more textual embeddings. The one or more performance metrics may be, but not limited to accuracy, precision, F1 score, computational resources required, training time, and/or the like. Upon determining the performance metric(s), the system establishes one or more objective functions. Such objective function(s) aim to maximize and/or minimize relevant performance metric(s) and may be defined based on requirements associated with the facility. With such functions, optimal weights are deduced for relevant performance metric(s). These optimal weights enable the system to select a machine learning model with a model index that is having the highest score.

Upon selection of such machine learning model which is optimal or best, the system aims to refine a model threshold of the selected machine learning model. That is, the system tries to optimize the model threshold. It is to be noted that the model threshold corresponds to a threshold with which the machine learning model binarizes its continuous predictions. To refine such threshold, the system relies on Bayesian update together with the observation dataset. In this regard, the system iteratively refines the model threshold (additionally, other model parameters) based on validated observation dataset and the feedback. Ultimately, such iterative process enhances the model performance. Such machine learning model may then be used to optimize one or more operations in the facility.

With this, the system makes sure to select and validate the most effective text embedding suitable for handling data associated with the facility though there are several embeddings available in market. Additionally, the system also improves operational accuracy of machine learning model(s) used for handling data associated with the facility based on the most effective choice of the text embedding. With this, precise insights such as correlations, trends, patterns, and/or the like along with accurate predictions may be derived from datasets associated with the facility. Also, the system described herein minimizes redundancy and optimizes various operations in the facility.

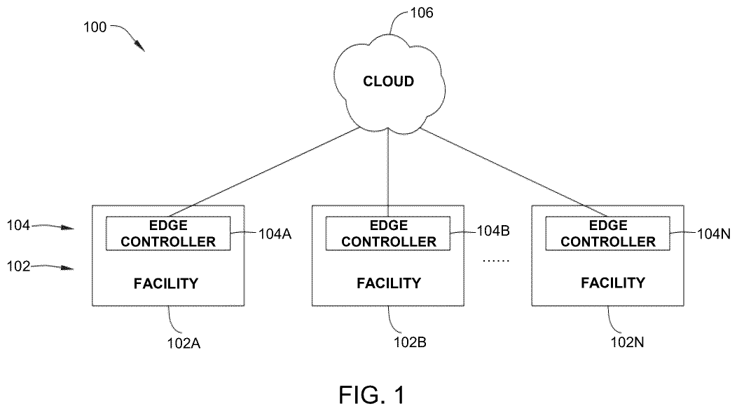

FIG. 1 illustrates a schematic diagram showing an exemplary environment comprising multiple facilities, in accordance with one or more example embodiments described herein. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may be related to life sciences sector. In this regard, the facility for example, may correspond to a pharmaceutical industry, a medical device company, a healthcare firm, and/or the like. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, the facility of the one or more facilities 102a, 102b, . . . 102n often employs several operations to cater various requirements of customers. These operations are often diverse in nature in the facility. For example, the operations may correspond to complaint management, compliance tracking, investigation process, recall management, patient record management, and/or the like. Each of such operations itself comprise huge amount of data. For example, with regards to complaint management, there may be millions of complaints received from customers across the globe. In another example, with regards to investigation process, there may be huge number of records that needs to be appropriately investigated by the facility. At times, the facility performs analysis of the data associated with such operations to derive insights and better handle the operations. However, traditional techniques like count vectorization have limitations as such techniques may fail to consider relationships between terms, may not capture semantic meaning of words in a dataset, and/or the like. Per this aspect, there exists a need for the facility to develop a framework for better analysis of the data in order to derive better insights and to thereby optimize operations in the facility.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on data exchanged & transacted in the facilities 102. In some example embodiments described herein, the cloud 106 represents a platform that comprises one or more services to assess one or more textual embeddings which are used to handle data associated with the facility. Per this aspect, the one or more services of the cloud 106 appropriately handle, process, and/or manage the data at the cloud 106. In this regard, the data at the cloud 106 may correspond to data associated with one or more operations (said alternatively, operational data) in the facility. For example, the data may correspond to a set of complaints received from customers and this may be associated with complaint management process in the facility. In another example, the data may correspond to medical records of patients with regards to patient record management process in the facility. Additionally, it is to be noted that the data may also comprise other metadata regarding the facility which is of relevance to the said data as well. Also, the cloud 106 may include and/or generate appropriate model(s) required to handle, process, and/or manage the data of a respective facility. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of operations or functions. In this regard, each of the facilities 102 may generate humongous data for respective operations. In some example embodiments, the cloud 106 may manage the data and/or automatically control operations in the facilities 102 using insights derived from appropriate model(s). In this regard, in the example shown in FIG. 1, each of the one or more facilities 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive the data from the respective facilities 102. In this regard, in some example embodiments, the necessary data in the respective facility may be provided by users such as customers and/or personnel associated with the respective facility. Also, in some example embodiments, the cloud 106 can transmit one or more instructions to an edge controller of the respective facility in order to optimize one or more operations in the respective facility. In some examples, the one or more edge controllers 104a, 104b, . . . 104n may operate as intermediary node to transact the data between the facilities 102 and/or the cloud 106. In some examples, each of the one or more edge controllers 104a, 104b, . . . 104n is capable of receiving the data from disparate data sources e.g., but not limited to, in different data formats and/or using various data communication protocols, from the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

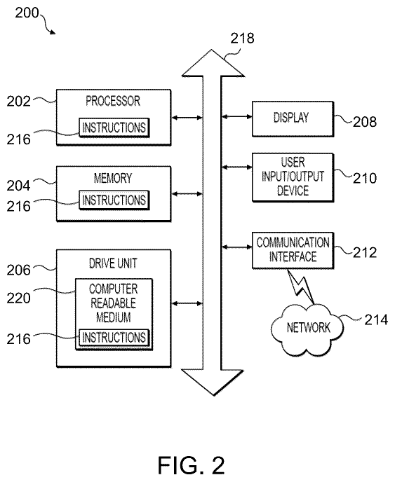

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

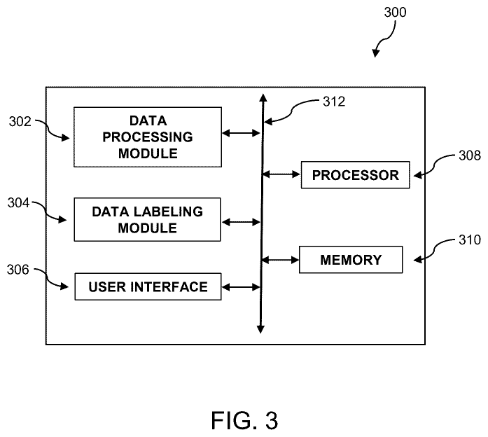

FIG. 3 illustrates a schematic diagram showing an implementation of an exemplary embedding assessment system, in accordance with one or more example embodiments described herein. In one or more example embodiments, the embedding assessment system 300 described herein automatically assesses one or more textual embeddings for handling data associated with a facility (for instance, one or more facilities 102a, 102b, . . . 102n as described in FIG. 1 of the current disclosure) and optimizing one or more operations in the facility. Generally, the facility maintains data sources such as repositories or databases to store data relevant to the facility. In this regard, the data may be associated with one or more operations in the facility. For example, the data may correspond to a set of complaints received from customers and this may be associated with complaint management operations. In another example, the data may correspond to medical records of patients with regards to patient record management operations. It is to be noted that some portion of this data may be unlabeled. Said alternatively, at least some portion of this data may be in its raw form without any specific label or defined explanation. The embedding assessment system 300 described herein initially retrieves unlabeled dataset associated with the facility. Then, the embedding assessment system 300 provides the unlabeled dataset to a language learning model. The language learning model may be, but not limited to Gemini, ChatGPT, and/or the like. The unlabeled dataset may be provided to the language learning model for labeling the unlabeled dataset. Additionally, the language learning model also receives appropriate instruction prompt(s) from a user associated with the facility along with the unlabeled dataset. In this regard, the embedding assessment system 300 then generates a labeled dataset considering the unlabeled dataset and instruction prompt(s) using the language learning model.

Using some portion of the labeled dataset, the embedding assessment system 300 then constructs a proxy task. The proxy task comprises one or more textual embeddings along with one or more evaluation metrics and one or more machine learning models. Per this aspect, the one or more textual embeddings comprise corresponding semantic encoding techniques to convert appropriate textual representations in the labeled dataset into appropriate vectors. While the one or more evaluation metrics are used to measure similarity between appropriate records in the labeled dataset and the one or more machine learning models are used to classify various datasets associated with the facility. The embedding assessment system 300 then executes the proxy task for each of the one or more textual embeddings. That is, appropriate vectors are compared for semantic similarity while the one or more machine learning models classify records in appropriate datasets. With this, the embedding assessment system 300 measures an accuracy of semantic similarity between related records that are compared. Based at least on such execution of the proxy task, the embedding assessment system 300 determines one or more performance metrics for each of the one or more textual embeddings. The one or more performance metrics may be, but not limited to accuracy, precision, F1 score, computational resources required, training time, and/or the like. Using the one or more performance metrics, a machine learning model from the one or more machine learning models is selected by the embedding assessment system 300. The selected machine learning model is then used by the embedding assessment system 300 to optimize the one or more operations in the facility. In this regard, the embedding assessment system 300 utilizes that textual embedding associated with the selected machine learning model to handle the data associated with corresponding operations. That is, using the selected machine learning model and its corresponding textual embedding, one or more insights from the data associated with corresponding operations is deduced. Such insights are then utilized to optimize the one or more operations in the facility.

In some example embodiments, the embedding assessment system 300 is a server system (e.g., a server device) that facilitates a data analytics platform between one or more computing devices, one or more data sources, and/or one or more facilities. In some example embodiments, the embedding assessment system 300 is a device with one or more processors and a memory. Also, in some example embodiments, the embedding assessment system 300 is implementable via the cloud 106. The embedding assessment system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the embedding assessment system 300 comprises one or more components (or one or more modules) such as, a data processing module 302, a data labeling module 304, and/or a user interface 306. Additionally, in one or more example embodiments, the embedding assessment system 300 comprises a processor 308 and/or a memory 310. In one or more example embodiments, the one or more components of the embedding assessment system 300 may be communicatively coupled to processor 308 and/or a memory 310 via a bus 312. In certain example embodiments, one or more aspects of the embedding assessment system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the embedding assessment system 300, a remote processor (e.g., a processor implemented on a server), and/or a virtual machine. In certain example embodiments, the processor 308 is in communication with the memory 310, the data processing module 302, the data labeling module 304, and/or the user interface 306 via the bus 312 to, for example, facilitate transmission of data between the processor 308, the memory 310, the data processing module 302, the data labeling module 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the embedding assessment system 300 to carry out various functions in accordance with one or more embodiments disclosed herein. In accordance with some example embodiments described herein, the memory 310 may correspond to an internal or external memory of the embedding assessment system 300. In some examples, the memory 310 may correspond to a database communicatively coupled to the embedding assessment system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the data processing module 302 of the embedding assessment system 300 retrieves unlabeled dataset associated with the facility. The unlabeled dataset often comprises data associated with one or more operations in the facility. For example, the unlabeled dataset may correspond to a specific set of complaints received from customers and this may be associated with complaint management operations. In another example, the data may correspond to specific medical records of patients with regards to patient record management operations. The unlabeled dataset may be stored in a database (or a repository) associated with the facility. It is to be noted that the unlabeled dataset may be stored in various electronic formats like images, documents, and/or the like in the database. The facility may maintain the database by regularly updating the unlabeled dataset in the database. In addition to the unlabeled dataset, the database may also contain other data associated with the facility. Also, the unlabeled dataset stored in the database may be timestamped and associated with identifiers and/or other metadata as well. It is to be noted that the data processing module 302 of the embedding assessment system 300 may retrieve only specific unlabeled dataset. In this regard, the data processing module 302 selectively chooses the unlabeled dataset that is to be retrieved from the database. Such selection is often based on one or more requirements in the facility. Per this aspect, a requirement may correspond to at least one operation that is to be optimized in the facility. For example, if an investigation process for certain complaints is to be optimized then only a specific set of complaints may be selected. Also, it is to be noted that the one or more requirements may be provided by a user associated with the facility (for example, personnel related to the facility) via the user interface 306. Additionally, the data processing module 302 may retrieve the unlabeled dataset spanning across a specific timeframe as well. In this regard, the timeframe may be expressed in terms of hours, days, weeks, months, and/or years. For example, the data processing module 302 may retrieve unlabeled dataset of last two days. In another example, the data processing module 302 may retrieve unlabeled dataset of last three weeks. Yet in another example, the data processing module 302 may retrieve unlabeled dataset of last four years. In this regard, the facility (or personnel associated with the facility) may choose the timeframe in order to retrieve the unlabeled dataset from the database. Based at least on such selection, the data processing module 302 retrieves the required unlabeled dataset from the database. It is to be noted that the unlabeled dataset may comprise relevant data in the form of records. That is, the unlabeled dataset comprises one or more data records (alternatively, referred to as one or more first records) related to relevant operations in the facility. For instance, an example unlabeled dataset may comprise a set of complaints received across a timeframe of one week and each complaint in this unlabeled dataset may serve as a data record. Upon retrieving such dataset, the data processing module 302 may also pre-process the unlabeled dataset. In this regard, the data processing module 302 may cleanse the unlabeled dataset to filter unwanted or redundant data records from the retrieved unlabeled dataset. This is done so that the unlabeled dataset is compatible for further processing by the data labeling module 304.

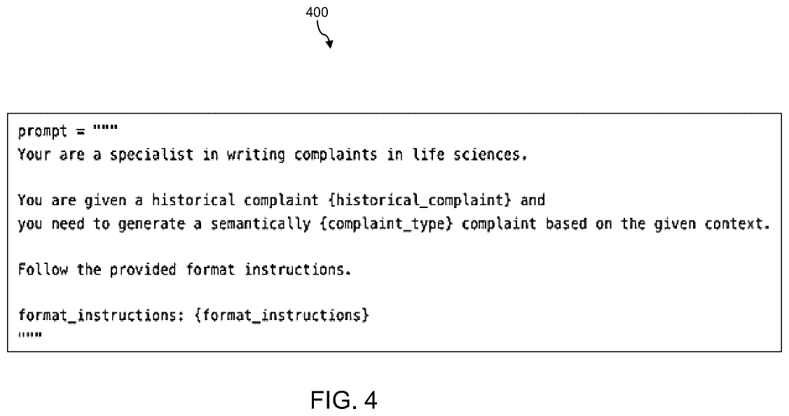

In one or more example embodiments described herein, the data processing module 302 provides the unlabeled dataset (upon retrieval from the database along with further appropriate pre-processing) to the data labeling module 304. In this regard, the unlabeled dataset is provided to a language learning model in the data labeling module 304 by the data processing module 302. The language learning model may correspond to a machine learning model capable of language generation and/or performing other natural language processing tasks. It is to be noted that the language learning model may be sufficiently trained as per expectations of the facility as well. Also, the language learning model may correspond to one of, but not limited to Gemini, ChatGPT, and/or the like. Additionally, the data processing module 302 also provides one or more instruction prompts to the data labeling module 304 along with the unlabeled dataset. The data processing module 302 receives such instruction prompts from the user associated with the facility (for example, personnel related to the facility). In this regard, in some example embodiments, the user may provide the instruction prompt(s) via the user interface 306 to the data processing module 302. Whereas in some other example embodiments, the user may provide the instruction prompt(s) via a display of a computing device (not shown). The computing device may be associated with one or more users such as personnel related to the facility and may be communicatively coupled to the embedding assessment system 300. The user interface 306 may correspond to a graphical user interface (GUI), a human computer interface (HCl), and/or any other type of display. It is to be appreciated that the display of the computing device may be similar to the user interface 306 described herein. Also, it is to be appreciated that the instruction prompt(s) may be provided in the form of text and/or audio to the data processing module 302. The one or more instruction prompts often correspond to one or more natural language statements provided by the user. Often, these prompts comprise instructions and/or requirements desired by the user in the facility. Per this aspect, at least some instruction prompts of the one or more instruction prompts relate to generating a semantic dataset relative to the unlabeled dataset, labeling the unlabeled dataset, and/or the like. For example, an instruction prompt may correspond to a statement from a user for generating a semantic dataset which is relevant to the unlabeled dataset provided to the language learning model. In another example, an instruction prompt may correspond to a statement from a user for labeling the unlabeled dataset upon generating a semantic dataset relative to the unlabeled dataset. Yet in another example, an instruction prompt may correspond to a statement from a user to refine an output provided by the language learning model. An exemplary user interface rendering one or more exemplary instruction prompts is also described in more details in accordance with FIG. 4 of the current disclosure. Upon receipt of the one or more instruction prompts, the data processing module 302 inputs the unlabeled dataset to the data labeling module 304 along with the one or more instruction prompts.

Then, in one or more example embodiments, the data labeling module 304 generates a labeled dataset using the language learning model. This labeled dataset is generated based at least on the unlabeled dataset provided to the data labeling module 304. To generate the labeled dataset, the data labeling module 304 initially analyzes the unlabeled dataset. In this regard, the language learning model in the data labeling module 304 analyzes the unlabeled dataset along with the one or more instruction prompts. Said alternatively, the language learning model analyzes each first record of the unlabeled dataset in light of the one or more instruction prompts. Upon analysis of the unlabeled dataset along with the one or more instruction prompts, the data labeling module 304 generates a semantic dataset. Provided that at least some of the instruction prompts mostly relate to generating a semantic dataset and labeling the unlabeled dataset, the data labeling module 304 in light of such instruction prompts generates the semantic dataset considering the unlabeled dataset. It is to be noted that the semantic dataset may correspond to randomly generated dataset by the language learning model based on the unlabeled dataset and the instruction prompt(s). Also, the semantic dataset described herein comprises one or more records (alternatively, referred to as one or more second records) likewise the one or more first records in the unlabeled dataset. Said alternatively, for each first record in the unlabeled dataset, the data labeling module 304 using the language learning model generates a corresponding second record as a part of the semantic dataset. Per this aspect, a number of records or a count of records in the unlabeled dataset and the semantic dataset may be same. Additionally, it is to be noted that the one or more second records in the semantic dataset may be similar and/or dissimilar to the one or more first records in the unlabeled dataset. For example, for an unlabeled dataset with ten historical complaints, the language learning model may generate a semantic dataset with ten complaints. That is, for each of the ten historical complaints in the unlabeled dataset, a corresponding complaint may be generated as the semantic dataset with ten complaints. Each complaint in the semantic dataset may be similar/dissimilar to its corresponding historical complaint in the unlabeled dataset. It is to be appreciated that in some instances the one or more second records in the semantic dataset may serve as a prediction of records which customer(s) is likely to submit to the facility.

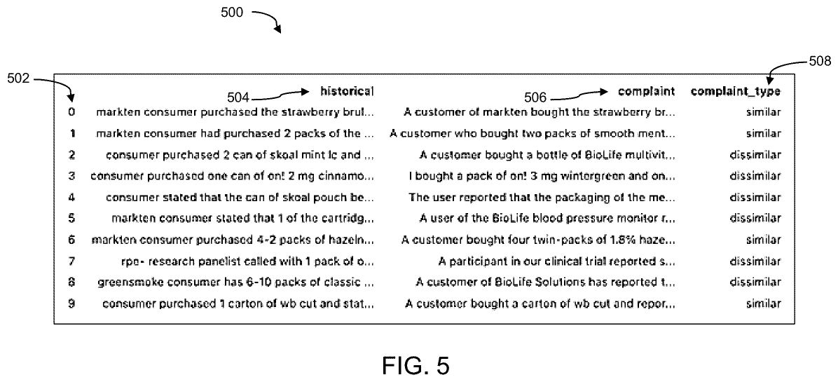

Further, the data labeling module 304 compares each first record in the unlabeled dataset with its corresponding second record in the semantic dataset. That is, all first records in the unlabeled dataset are compared with their corresponding second records in the semantic dataset. The data labeling module 304 performs such a comparison to determine similarity/dissimilarity between a first record in the unlabeled dataset and its corresponding second record in the semantic dataset. Based on the comparison, the data labeling module 304 labels each first record in the unlabeled dataset along with its corresponding second record in the semantic dataset with a label. This constitutes the labeled dataset generated by the data labeling module 304. The label described herein corresponds to an indicator indicative of a similarity level between a first record in the unlabeled dataset when compared to its corresponding second record in the semantic dataset. That is, a first record in the unlabeled dataset and its corresponding second record from the semantic dataset will be labeled with a same label. Also, it is to be noted that the similarity level is determined based on the comparison performed earlier by the data labeling module 304. An exemplary labeled dataset generated by the data labeling module 304 is also described in more details in accordance with FIG. 5 of the current disclosure. Furthermore, the data labeling module 304 outputs the labeled dataset generated by the language learning model. This is to facilitate rendering of the labeled dataset for instance, via the user interface 306. Per this aspect, the user associated with the facility may view the labeled dataset generated by the language learning model. If required, the user may also provide one or more additional instruction prompts via the user interface 306. These additional instruction prompt(s) may be directed to refine the labeled dataset. Upon such refinements, that is considering at least the additional instruction prompt(s), the data labeling module 304 may then output a refined version of the labeled dataset as well. Additionally, such refined version of the labeled dataset may be rendered on the user interface 306 as well. Also, it is to be appreciated that the data labeling module 304 may also allow the user to provide a prompt acknowledging the labeled dataset that is generated by the data labeling module 304. Based at least on such prompts, the data labeling module 304 finalizes the labeled dataset for further processing or procedures which is further explained below in detail.

Then, in one or more example embodiments, the data labeling module 304 employs one or more sampling techniques to categorize the labeled dataset. In this regard, a sampling technique of the one or more sampling techniques may correspond to a stratified sampling technique. Using such sampling technique(s), the data labeling module 304 then categorizes the labeled dataset into one or more portions. In this regard, the one or more portions correspond to training dataset, validation dataset, and observation dataset. It is to be noted that count of records or content in the training dataset may be relatively greater than that in the validation dataset and the observation dataset. Upon categorization of the labeled dataset into the said portions, the data labeling module 304 renders a portion of the one or more portions say, via the user interface 306. In this regard, the portion often corresponds to the observation dataset that is rendered say, via the user interface 306. This is to facilitate the user associated with the facility to validate the portion that is, the observation dataset. Per this aspect, the data labeling module 304 also allows the user to provide feedback upon validation of the observation dataset. The feedback received by the data labeling module 304 may be related to quality of the labeled dataset, accuracy of labeling by the language learning model, and/or the like.

Also, in the meantime in one or more example embodiments described herein, the data labeling module 304 constructs a proxy task using the one or more portions of the labeled dataset. In this regard, the data labeling module 304 relies on the training dataset and the validation dataset of the one or more portions. That is, the data labeling module 304 creates the proxy task using the training dataset and the validation dataset from the labeled dataset that is categorized. The proxy task comprises one or more textual embeddings along with one or more evaluation metrics and one or more machine learning models. Each textual embedding comprises a corresponding semantic encoding technique that converts textual representations into vectorial representations. In this regard, the one or more textual embeddings may be transformer-based embeddings which may be, but not limited to BERT (Bidirectional Encoder Representations from Transformers), GPT (Generative Pre-trained Transformer), and/or the like. Then, the data labeling module 304 vectorizes one or more textual representations in each first record of the unlabeled dataset and its corresponding second record in the semantic dataset using a corresponding textual embedding of the one or more textual embeddings. That is, using appropriate textual embedding, the data labeling module 304 converts textual representations in a first record into vectorial representations while textual representations in a corresponding second record are also converted into vectorial representations. It is to be appreciated that the data labeling module 304 may also rely on multiple textual embeddings at times to vectorize textual representations. With this, the data labeling module 304 deduces vectorial equivalents of textual representations in each first record and its corresponding second record as well. Upon vectorizing textual representations in first record(s) and corresponding second record(s), the data labeling module 304 defines the one or more evaluation metrics. The one or more evaluation metrics are used to measure similarity between respective vectors of each first record of the unlabeled dataset and its corresponding second record in the semantic dataset. That is, the one or more evaluation metrics measure similarity between vectorial representation associated with a first record and vectorial representation associated with a second record which is related to the first record. It is to be noted that the one or more evaluation metrics may be, but not limited to Euclidean distance, Pearson correlation coefficient, Cosine similarity, and/or the like. Whereas the one or more machine learning models in the proxy task often correspond to one or more classification models that are used to classify various datasets associated with the facility. It is to be noted that each of the one or more machine learning models in the proxy task are sufficiently trained to classify required datasets. Also, it is to be noted that each textual embedding from the one or more textual embeddings may be related to a machine learning model of the one or more machine learning models. It is to be appreciated that each of the one or more machine learning models may have their own model index.

Upon construction of the proxy task, in one or more example embodiments described herein, the data labeling module 304 executes the proxy task for each of the one or more textual embeddings. Also, the execution of the proxy task facilitates assessment of the most optimal textual embedding and its corresponding machine learning model to handle dataset(s) associated with the facility and to optimize operation(s) in the facility. In this regard, the data labeling module 304 compares the respective vectors of each first record of the unlabeled dataset and its corresponding second record in the semantic dataset. More specifically, the data labeling module 304 performs the comparison to determine similarity between the respective vectors. Per this aspect, the data labeling module 304 considers the one or more evaluation metrics to determine similarity between the respective vectors. Based on the comparison, the data labeling module 304 then measures a similarity score for a first record and its corresponding second record. That is, using the evaluation metric(s), the data labeling module 304 measures similarity between vectors of first record and its corresponding second record. In this regard, the data labeling module 304 yields a continuous measure between 0 and 1 in view of the similarity measured between two vectors. That is, the similarity between two vectors is expressed in the form of a score on a scale of 0 to 1. This score corresponds to the similarity score indicative of a degree of similarity between a first record from the unlabeled dataset and a corresponding second record in the semantic dataset. Additionally, the similarity score may be applicable to an appropriate textual embedding as well. Considering the similarity score, respective records in the training dataset and the validation dataset are classified by the data labeling module 304 using corresponding machine learning models. Such a classification by the data labeling module 304 is based on the similarity score. That is, considering the similarity score measured for each first record and its corresponding second record, the data labeling module 304 classifies appropriate records in the training dataset and the validation dataset using appropriate machine learning model(s). Then, the data labeling module 304 based on the classification, measures an accuracy score for each first record of the unlabeled dataset and its corresponding second record in the semantic dataset. In this regard, the accuracy score indicates an accuracy of semantic similarity that is determined between related records which are compared.

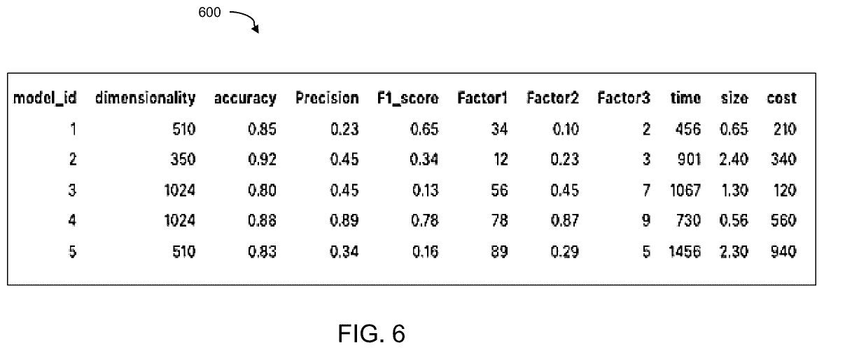

Based on the execution of the proxy task, in one or more example embodiments described herein, the data labeling module 304 determines one or more performance metrics for each of the one or more textual embeddings. In this regard, the one or more performance metrics may be, but not limited to accuracy, precision, F1 score, computational resources required, training time, and/or the like. It is to be appreciated that the one or more performance metrics for each of the one or more textual embeddings may also be rendered say, via the user interface 306 to facilitate the user associated with the facility for viewing the one or more performance metrics. An exemplary representation of the one or more performance metrics is also described in more details in accordance with FIG. 6 of the current disclosure. Using the one or more performance metrics, the data labeling module 304 establishes one or more objective functions. Such objective function(s) aim to maximize and/or minimize at least some of the one or more performance metrics. The objective function(s) may be defined based on the one or more requirements associated with the facility. With such objective functions, one or more optimal weights are deduced for relevant performance metric(s). The one or more optimal weights enable the data labeling module 304 to select one machine learning model from the one or more machine learning models. In this regard, the selected machine learning model may correspond to that model with a model index which is having optimal weight(s).

Upon selection of the machine learning model from the one or more machine learning models, in one or more example embodiments, the data labeling module 304 aims to refine a model threshold of the selected machine learning model. In this regard, the data labeling module 304 determines a model threshold of the selected machine learning model. The model threshold corresponds to a threshold with which the selected machine learning model binarizes one or more predictions. Upon determinization of the model threshold, the data labeling module 304 refines the model threshold. Such refinement is based on the feedback received from the user on the observation dataset. Additionally, the refinement is also based on the observation dataset and at least one first algorithm. In this regard, the at least one first algorithm in the data labeling module 304 may correspond to Bayesian update. Also, it is to be appreciated that the data labeling module 304 may also comprise other algorithms similar to Bayesian update as part of the at least one first algorithm. More particularly, to refine the model threshold, the data labeling module 304 relies on the at least one first algorithm (like, Bayesian update) together with the observation dataset. In this regard, the data labeling module 304 iteratively refines the model threshold (additionally, other model parameters) based on the validated observation dataset and the feedback. Ultimately, such iterative process enhances performance of the selected machine learning model. Additionally, it is to be noted that textual embedding(s) associated with the selected machine learning model may also be deemed as the optimal textual embedding for handling datasets associated with the facility.

Further, in one or more example embodiments described herein, the data labeling module 304 optimizes one or more operations in the facility using the selected machine learning model. In this regard, the selected machine learning model may optimize operations such as investigation process, compliant management, and/or the like that are stated earlier in the current disclosure. With regards to optimization of the one or more operations, the data labeling module 304 provides one or more insights that facilitate optimization of appropriate operation(s) in the facility. The one or more insights are derived using the selected machine learning model (along with its related textual embedding) considering the unlabeled dataset associated with the facility. In this regard, the one or more insights may be, but not limited to correlations, trends, patterns, predictions, and/or the like derived from the unlabeled dataset associated with the facility. With this, the embedding assessment system 300 makes sure to select and validate the most effective text embedding suitable for handling data associated with the facility though there are several embeddings available in market. Additionally, the embedding assessment system 300 also improves operational accuracy of machine learning model(s) used for handling data associated with the facility based on the most effective choice of the text embedding. With this, precise insights such as correlations, trends, patterns, and/or the like along with accurate predictions may be derived from datasets associated with the facility. Also, the embedding assessment system 300 described herein minimizes redundancy and optimizes various operations in the facility.

FIG. 4 illustrates a schematic diagram showing an exemplary user interface rendering one or more exemplary instruction prompts, in accordance with one or more example embodiments described herein. The exemplary user interface 400 described herein may correspond to the user interface 306 and/or the display described in accordance with FIG. 3 of the current disclosure. The user interface 400 allows user(s) associated with the facility to provide one or more instruction prompts to the language learning model (as described in FIG. 3 of the current disclosure). For example, as illustrated in FIG. 4, a user may provide one or more natural language statements to the language learning model. Such statements may correspond to instructions and/or requirements desired by the user in the facility. For instance, such statements may correspond to an instruction to generate a semantic dataset relative to an unlabeled dataset, an instruction to label an unlabeled dataset, an instruction to provide rationale/reasoning for generating a particular semantic dataset, an instruction to provide rationale/reasoning for labeling a particular record, a specific formatting in which the user desires a response from the language learning model, an additional prompt to refine generated semantic dataset, an additional prompt to refine labels in a labeled dataset, an acknowledgement for generating semantic dataset by the language learning model, an acknowledgement for generating labeled dataset by the language learning model, a feedback to improve dataset generating capabilities, a feedback to improve dataset generating capabilities, and/or the like. Additionally, the user may also provide the unlabeled dataset that is, a set of historical complaints as illustrated in the exemplary user interface 400. Considering such instruction prompts, the language learning model generates labeled dataset as described in FIG. 3 of the current disclosure.

FIG. 5 illustrates a schematic diagram showing an exemplary labeled dataset, in accordance with one or more example embodiments described herein. The exemplary labeled dataset 500 described herein comprises record identifiers 502, unlabeled dataset 504 (or alternatively referred to as first records 504, illustrated as ‘historical’ in FIG. 5), semantic dataset 506 (or alternatively referred to as second records 506, illustrated as ‘complaint’ in FIG. 5), and labels 508 (illustrated as ‘complaint_type’ in FIG. 5). The language learning model of the data labeling module 304 generates the labeled dataset 500 (as described in FIG. 3 of the current disclosure). A record identifier of the record identifiers 502 described herein corresponds to an identifier for a first record in the unlabeled dataset. Additionally, the same identifier may be used for a second record in the semantic dataset as well as the second record in the semantic dataset is related to the first record in the unlabeled dataset. Further, the unlabeled dataset 504 illustrated herein comprises a set of ten historical complaints with corresponding record identifiers 502. While the semantic dataset 506 comprise a set of ten semantically generated complaints by the language learning model. The language learning model generates the semantic dataset 506 based at least on the unlabeled dataset 504. As illustrated, for each first record in the unlabeled dataset 504, there exists a corresponding second record in the semantic dataset 506. Each record in the unlabeled dataset may be either similar or dissimilar to its corresponding second record in the semantic dataset. In this regard, considering either similarity/dissimilarity, the data labeling module 304 labels each first record and its corresponding second record with a label. As illustrated, each record in the unlabeled dataset 504 and its corresponding record in the semantic dataset 506 is labeled with appropriate labels 508. Such labeled dataset is used to assess one or more textual embeddings as described in FIG. 3 of the current disclosure

FIG. 6 illustrates a schematic diagram showing an exemplary representation of one or more performance metrics, in accordance with one or more example embodiments described herein. The exemplary representation 600 described herein comprises the one or more performance metrics (as described in FIG. 3 of the current disclosure). The exemplary representation 600 described herein corresponds to a tabular representation of the one or more performance metrics. However, it is to be appreciated that the one or more performance metrics may be represented in any other format/representation as well. The representation 600 illustrated in FIG. 6 comprises model_id, dimensionality, accuracy, precision, F1 score, factor 1, factor 2, factor 3, time, size, and cost. In this regard, model_id may correspond to an identifier associated with a machine learning model of the one or more machine learning models in the proxy task. While dimensionality may represent size of vectors associated with first record and its related second record. Also, dimensionality may represent size of a machine learning model of the one or more machine learning models. In the representation 600, accuracy and/or precision may represent an accuracy of semantic similarity between related records. While factors 1-3, time, size, and cost may correspond to one or more requirements desired in the facility. It is to be noted that metrics such as model_id, dimensionality, and/or the like may be static in nature whereas metrics such as time, size, and cost may be dynamic in nature based on needs/requirements in the facility.

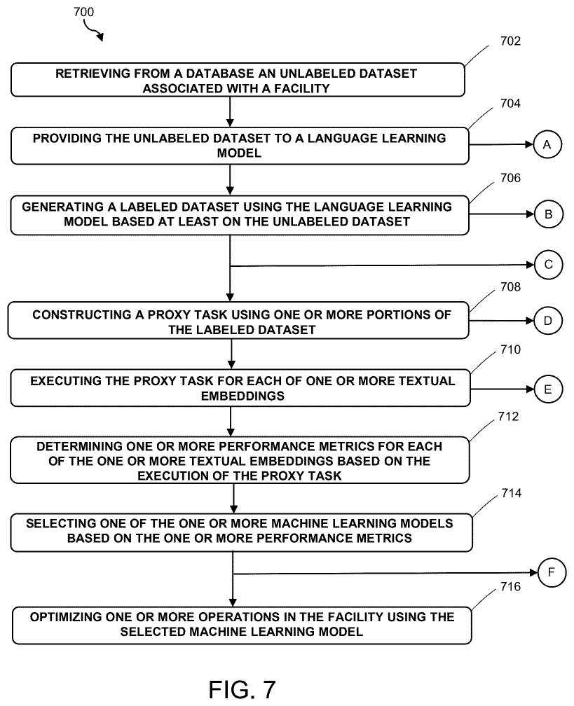

FIG. 7 illustrates a flowchart showing a method described in accordance with one or more example embodiments described herein. In this regard, FIG. 7 illustrates operations that may be performed by the embedding assessment system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the embedding assessment system 300 comprises means such as, the data processing module 302 to retrieve an unlabeled dataset associated with a facility from a database. In this regard, the data processing module 302 may initially select the unlabeled dataset that is to be retrieved from the database. This selection may be based on one or more requirements in the facility such that a requirement of the one or more requirements corresponds to at least one operation that is to be optimized in the facility. Upon such selection, the data processing module 302 may retrieve the unlabeled dataset from the database. At step 704 of the exemplary flowchart 700, the embedding assessment system 300 comprises means such as, the data processing module 302 to provide the unlabeled dataset to a language learning model. At step 706 of the exemplary flowchart 700, the embedding assessment system 300 comprises means such as, the data labeling module 304 to generate a labeled dataset using the language learning model based at least on the unlabeled dataset. At step 708 of the exemplary flowchart 700, the embedding assessment system 300 comprises means such as, the data labeling module 304 to construct a proxy task using one or more portions of the labeled dataset. In this regard, the proxy task comprises the one or more textual embeddings along with one or more evaluation metrics and one or more machine learning models. At step 710 of the exemplary flowchart 700, the embedding assessment system 300 comprises means such as, the data labeling module 304 to execute the proxy task for each of the one or more textual embeddings. At step 712 of the exemplary flowchart 700, the embedding assessment system 300 comprises means such as, the data labeling module 304 to determine one or more performance metrics for each of the one or more textual embeddings based on the execution of the proxy task. At step 714 of the exemplary flowchart 700, the embedding assessment system 300 comprises means such as, the data labeling module 304 to select one of the one or more machine learning models based on the one or more performance metrics. At step 716 of the exemplary flowchart 700, the embedding assessment system 300 comprises means such as, the data labeling module 304 to optimize one or more operations in the facility using the selected machine learning model.

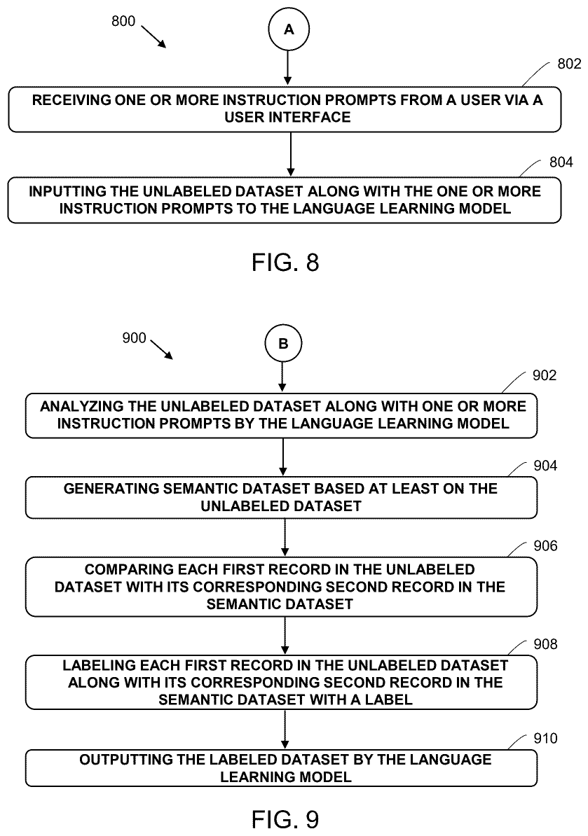

FIG. 8 illustrates a flowchart showing a method described in accordance with one or more example embodiments described herein. In this regard, FIG. 8 illustrates operations that may be performed by the embedding assessment system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the embedding assessment system 300 comprises means such as, the data processing module 302 and/or the user interface 306 to receive one or more instruction prompts from a user. At step 804 of the exemplary flowchart 800, the embedding assessment system 300 comprises means such as, the data processing module 302 to input the unlabeled dataset along with the one or more instruction prompts to the language learning model.

FIG. 9 illustrates a flowchart showing a method described in accordance with one or more example embodiments described herein. In this regard, FIG. 9 illustrates operations that may be performed by the embedding assessment system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the embedding assessment system 300 comprises means such as, the data labeling module 304 to analyze the unlabeled dataset along with one or more instruction prompts using the language learning model. At step 904 of the exemplary flowchart 900, the embedding assessment system 300 comprises means such as, the data labeling module 304 to generate semantic dataset based at least on the unlabeled dataset. At step 906 of the exemplary flowchart 900, the embedding assessment system 300 comprises means such as, the data labeling module 304 to compare each first record in the unlabeled dataset with its corresponding second record in the semantic dataset. At step 908 of the exemplary flowchart 900, the embedding assessment system 300 comprises means such as, the data labeling module 304 to label each first record in the unlabeled dataset along with its corresponding second record in the semantic dataset with a label. At step 910 of the exemplary flowchart 900, the embedding assessment system 300 comprises means such as, the data labeling module 304 to output the labeled dataset by the language learning model.

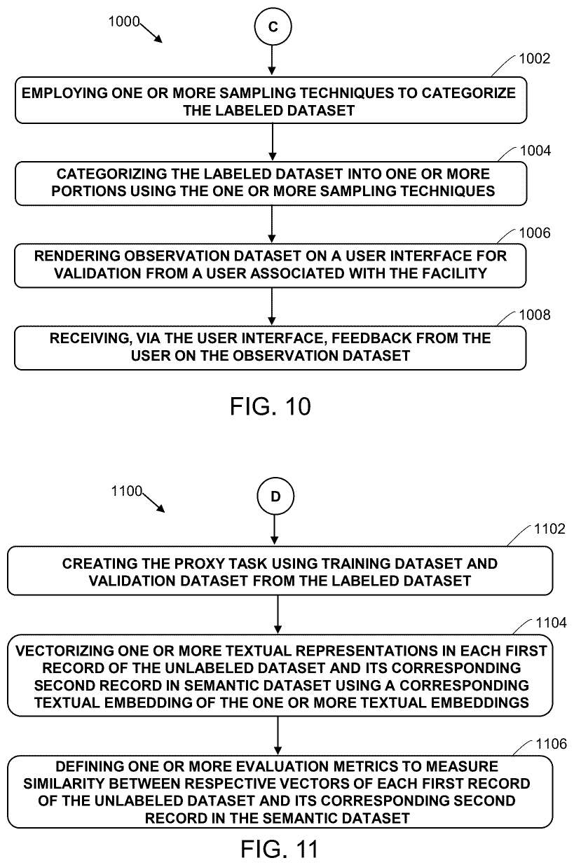

FIG. 10 illustrates a flowchart showing a method described in accordance with one or more example embodiments described herein. In this regard, FIG. 10 illustrates operations that may be performed by the embedding assessment system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the embedding assessment system 300 comprises means such as, the data labeling module 304 to employ one or more sampling techniques to categorize the labeled dataset. At step 1004 of the exemplary flowchart 1000, the embedding assessment system 300 comprises means such as, the data labeling module 304 to categorize the labeled dataset into one or more portions using the one or more sampling techniques. At step 1006 of the exemplary flowchart 1000, the embedding assessment system 300 comprises means such as, the data labeling module 304 and/or the user interface 306 to render observation dataset for validation from a user associated with the facility. At step 1008 of the exemplary flowchart 1000, the embedding assessment system 300 comprises means such as, the data labeling module 304 and/or the user interface 306 to receive feedback from the user on the observation dataset.

FIG. 11 illustrates a flowchart showing a method described in accordance with one or more example embodiments described herein. In this regard, FIG. 11 illustrates operations that may be performed by the embedding assessment system 300. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100. At step 1102 of the exemplary flowchart 1100, the embedding assessment system 300 comprises means such as, the data labeling module 304 to create the proxy task using training dataset and validation dataset from the labeled dataset. At step 1104 of the exemplary flowchart 1100, the embedding assessment system 300 comprises means such as, the data labeling module 304 to vectorize one or more textual representations in each first record of the unlabeled dataset and its corresponding second record in semantic dataset using a corresponding textual embedding of the one or more textual embeddings. At step 1106 of the exemplary flowchart 1100, the embedding assessment system 300 comprises means such as, the data labeling module 304 to define one or more evaluation metrics to measure similarity between respective vectors of each first record of the unlabeled dataset and its corresponding second record in the semantic dataset.

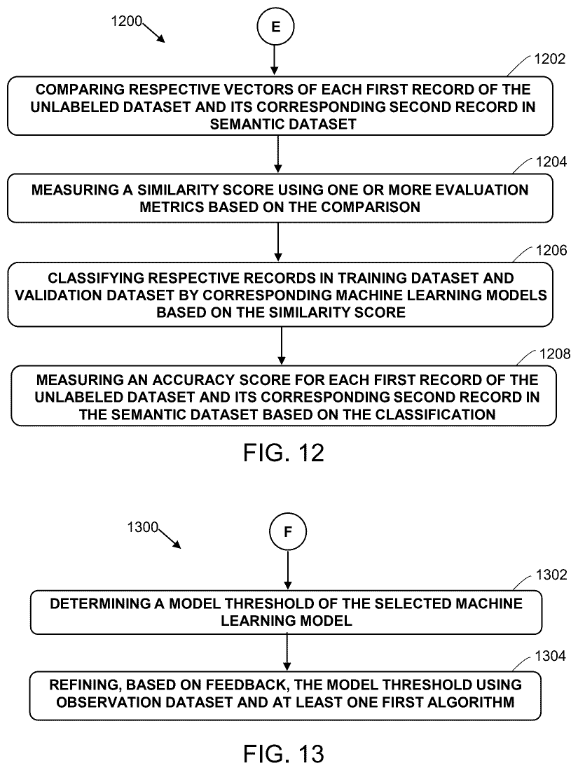

FIG. 12 illustrates a flowchart showing a method described in accordance with one or more example embodiments described herein. In this regard, FIG. 12 illustrates operations that may be performed by the embedding assessment system 300. In some embodiments, the example method 1200 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1200. At step 1202 of the exemplary flowchart 1200, the embedding assessment system 300 comprises means such as, the data labeling module 304 to compare respective vectors of each first record of the unlabeled dataset and its corresponding second record in semantic dataset. At step 1204 of the exemplary flowchart 1200, the embedding assessment system 300 comprises means such as, the data labeling module 304 to measure a similarity score using one or more evaluation metrics based on the comparison. At step 1206 of the exemplary flowchart 1200, the embedding assessment system 300 comprises means such as, the data labeling module 304 to classify respective records in training dataset and validation dataset by corresponding machine learning models based on the similarity score. At step 1208 of the exemplary flowchart 1200, the embedding assessment system 300 comprises means such as, the data labeling module 304 to measure an accuracy score for each first record of the unlabeled dataset and its corresponding second record in the semantic dataset based on the classification.

FIG. 13 illustrates a flowchart showing a method described in accordance with one or more example embodiments described herein. In this regard, FIG. 13 illustrates operations that may be performed by the embedding assessment system 300. In some embodiments, the example method 1300 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1300. At step 1302 of the exemplary flowchart 1300, the embedding assessment system 300 comprises means such as, the data labeling module 304 to determine a model threshold of the selected machine learning model. At step 1304 of the exemplary flowchart 1300, the embedding assessment system 300 comprises means such as, the data labeling module 304 to refine based on feedback, the model threshold using observation dataset and at least one first algorithm.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,”“an”or “the”is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content”are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for assessing one or more textual embeddings using an unlabeled dataset, the method comprising:
retrieving from a database the unlabeled dataset associated with a facility;
providing the unlabeled dataset to a language learning model;
generating a labeled dataset using the language learning model based at least on the unlabeled dataset;
constructing a proxy task using one or more portions of the labeled dataset, wherein the proxy task comprises the one or more textual embeddings along with one or more evaluation metrics and one or more machine learning models;
executing the proxy task for each of the one or more textual embeddings;
determining one or more performance metrics for each of the one or more textual embeddings based on the execution of the proxy task;
selecting one of the one or more machine learning models based on the one or more performance metrics; and
optimizing one or more operations in the facility using the selected machine learning model.

2. The method of claim 1, wherein retrieving the unlabeled dataset comprises:
selecting the unlabeled dataset based on one or more requirements in the facility, wherein a requirement of the one or more requirements corresponds to at least one operation that is to be optimized in the facility; and
retrieving the unlabeled dataset based on the selection.

3. The method of claim 1, wherein providing the unlabeled dataset comprises:
receiving one or more instruction prompts from a user via a user interface, wherein the one or more instruction prompts relate to: generating a semantic dataset relative to the unlabeled dataset and labeling the unlabeled dataset; and
inputting the unlabeled dataset along with the one or more instruction prompts to the language learning model.

4. The method of claim 3, wherein generating the labeled dataset comprises:
analyzing the unlabeled dataset along with the one or more instruction prompts by the language learning model, wherein the unlabeled dataset comprises one or more first records;
generating the semantic dataset based at least on the unlabeled dataset, wherein the semantic dataset comprises a corresponding second record for each of the one or more first records in the unlabeled dataset;
comparing each first record in the unlabeled dataset with its corresponding second record in the semantic dataset;
labeling each first record in the unlabeled dataset along with its corresponding second record in the semantic dataset with a label, wherein the label corresponds to an indicator indicative of a similarity level between a first record in the unlabeled dataset when compared to its corresponding second record in the semantic dataset; and
outputting the labeled dataset by the language learning model.

5. The method of claim 1, further comprising rendering the labeled dataset on a user interface.

6. The method of claim 1, further comprising:
employing one or more sampling techniques to categorize the labeled dataset, wherein a sampling technique of the one or more sampling techniques corresponds to a stratified sampling technique;
categorizing the labeled dataset into the one or more portions using the one or more sampling techniques, wherein the one or more portions comprise training dataset, validation dataset, and observation dataset;
rendering the observation dataset on a user interface for validation from a user associated with the facility; and
receiving, via the user interface, feedback from the user on the observation dataset.

7. The method of claim 6, wherein construction of the proxy task comprises:
creating the proxy task using the training dataset and the validation dataset from the labeled dataset;
vectorizing one or more textual representations in each first record of the unlabeled dataset and its corresponding second record in the semantic dataset using a corresponding textual embedding of the one or more textual embeddings; and
defining the one or more evaluation metrics to measure similarity between respective vectors of each first record of the unlabeled dataset and its corresponding second record in the semantic dataset.

8. The method of claim 7, wherein executing the proxy task comprises:
comparing the respective vectors of each first record of the unlabeled dataset and its corresponding second record in the semantic dataset;
measuring a similarity score using the one or more evaluation metrics based on the comparison, wherein the similarity score indicates a degree of similarity between a first record from the unlabeled dataset and a corresponding second record in the semantic dataset;
classifying respective records in the training dataset and the validation dataset by corresponding machine learning models based on the similarity score; and
measuring an accuracy score for each first record of the unlabeled dataset and its corresponding second record in the semantic dataset based on the classification.

9. The method of claim 6, further comprising:
determining a model threshold of the selected machine learning model, wherein the model threshold corresponds to a threshold with which the selected machine learning model binarizes one or more predictions; and
refining, based on the feedback, the model threshold using the observation dataset and at least one first algorithm, wherein the at least one first algorithm corresponds to Bayesian update.

10. A system for assessing one or more textual embeddings using an unlabeled dataset, the system comprising:
a processor;
a memory communicatively coupled to the processor, wherein the memory comprises one or more instructions which when executed by the processor, cause the processor to:
retrieve from a database the unlabeled dataset associated with a facility;
provide the unlabeled dataset to a language learning model;
generate a labeled dataset using the language learning model based at least on the unlabeled dataset;
construct a proxy task using one or more portions of the labeled dataset, wherein the proxy task comprises the one or more textual embeddings along with one or more evaluation metrics and one or more machine learning models;
execute the proxy task for each of the one or more textual embeddings;
determine one or more performance metrics for each of the one or more textual embeddings based on the execution of the proxy task;
select one of the one or more machine learning models based on the one or more performance metrics; and
optimize one or more operations in the facility using the selected machine learning model.

11. The system of claim 10, wherein the processor is further configured to:
select the unlabeled dataset based on one or more requirements in the facility, wherein a requirement of the one or more requirements corresponds to at least one operation that is to be optimized in the facility; and
retrieve the unlabeled dataset based on the selection.

12. The system of claim 10, wherein the processor is further configured to:
receive one or more instruction prompts from a user via a user interface, wherein the one or more instruction prompts relate to: generating a semantic dataset relative to the unlabeled dataset and labeling the unlabeled dataset; and
input the unlabeled dataset along with the one or more instruction prompts to the language learning model.

13. The system of claim 12, wherein the processor is further configured to:
analyze the unlabeled dataset along with the one or more instruction prompts by the language learning model, wherein the unlabeled dataset comprises one or more first records;
generate the semantic dataset based at least on the unlabeled dataset, wherein the semantic dataset comprises a corresponding second record for each of the one or more first records in the unlabeled dataset;
compare each first record in the unlabeled dataset with its corresponding second record in the semantic dataset;
label each first record in the unlabeled dataset along with its corresponding second record in the semantic dataset with a label, wherein the label corresponds to an indicator indicative of a similarity level between a first record in the unlabeled dataset when compared to its corresponding second record in the semantic dataset; and
output the labeled dataset by the language learning model.

14. The system of claim 10, wherein the processor is further configured to:
employ one or more sampling techniques to categorize the labeled dataset, wherein a sampling technique of the one or more sampling techniques corresponds to a stratified sampling technique;
categorize the labeled dataset into the one or more portions using the one or more sampling techniques, wherein the one or more portions comprise training dataset, validation dataset, and observation dataset;
render the observation dataset on a user interface for validation from a user associated with the facility; and
receive, via the user interface, feedback from the user on the observation dataset.

15. The system of claim 14, wherein the processor is further configured to:
create the proxy task using the training dataset and the validation dataset from the labeled dataset;
vectorize one or more textual representations in each first record of the unlabeled dataset and its corresponding second record in the semantic dataset using a corresponding textual embedding of the one or more textual embeddings; and
define the one or more evaluation metrics to measure similarity between respective vectors of each first record of the unlabeled dataset and its corresponding second record in the semantic dataset.

16. The system of claim 15, wherein the processor is further configured to:
compare the respective vectors of each first record of the unlabeled dataset and its corresponding second record in the semantic dataset;
measure a similarity score using the one or more evaluation metrics based on the comparison, wherein the similarity score indicates a degree of similarity between a first record from the unlabeled dataset and a corresponding second record in the semantic dataset;
classify respective records in the training dataset and the validation dataset by corresponding machine learning models based on the similarity score; and
measure an accuracy score for each first record of the unlabeled dataset and its corresponding second record in the semantic dataset based on the classification.

17. The system of claim 14, wherein the processor is further configured to:
determine a model threshold of the selected machine learning model, wherein the model threshold corresponds to a threshold with which the selected machine learning model binarizes one or more predictions; and
refine, based on the feedback, the model threshold using the observation dataset and at least one first algorithm, wherein the at least one first algorithm corresponds to Bayesian update.

18. A non-transitory, computer-readable storage medium having stored thereon executable instructions that, when executed by one or more processors, cause the one or more processors to:
retrieve from a database an unlabeled dataset associated with a facility;
provide the unlabeled dataset to a language learning model;
generate a labeled dataset using the language learning model based at least on the unlabeled dataset;
construct a proxy task using one or more portions of the labeled dataset, wherein the proxy task comprises the one or more textual embeddings along with one or more evaluation metrics and one or more machine learning models;
execute the proxy task for each of the one or more textual embeddings;
determine one or more performance metrics for each of the one or more textual embeddings based on the execution of the proxy task;
select one of the one or more machine learning models based on the one or more performance metrics; and
optimize one or more operations in the facility using the selected machine learning model.

19. The non-transitory, computer-readable storage medium of claim 18, wherein the one or more processors is further configured to:
select the unlabeled dataset based on one or more requirements in the facility, wherein a requirement of the one or more requirements corresponds to at least one operation that is to be optimized in the facility; and
retrieve the unlabeled dataset based on the selection, wherein the unlabeled dataset comprises one or more first records.

20. The non-transitory, computer-readable storage medium of claim 18, wherein the one or more processors is further configured to:
receive one or more instruction prompts from a user via a user interface, wherein the one or more instruction prompts relate to: generating a semantic dataset relative to the unlabeled dataset and labeling the unlabeled dataset; and
input the unlabeled dataset along with the one or more instruction prompts to the language learning model.
